(19) United States
(12) Patent Application Publication
(10) Pub. No.: US 2026/0175489 A1
(43) Pub. Date: Jun. 25, 2026

(54) INJECTION MOLDING DEVICE AND INJECTION UNIT

(71) Applicant: SEIKO EPSON CORPORATION, Tokyo (JP)

(72) Inventors: Yusuke TAKIZAWA, AZUMINO-SHI (JP); Kazuyuki HARAYAMA, MATSUMOTO-SHI (JP)

(73) Assignee: SEIKO EPSON CORPORATION, Tokyo (JP)

(21) Appl. No.: 19/430,337

(22) Filed: Dec. 23, 2025

(30) Foreign Application Priority Data
Dec. 25, 2024 (JP) 2024-228273

(51) Int. Cl. B29C 45/23; B29C 45/07; B29C 45/76

(52) U.S. Cl. CPC B29C 45/23; B29C 45/07; B29C 45/7613

(57) ABSTRACT

An injection molding device includes an injection unit and a molding die opening and closing unit. The injection unit includes a material supply port, a material 1 flow path that communicates with the material supply port and through which the material flows, an injection control section that includes a cylinder communicating with the material flow path and a plunger, and that controls injection of the material, and a nozzle section communicating with the cylinder and configured to inject the material. The material flow path includes a first flow path that communicates with the cylinder and a second flow path extending in a second direction intersecting a first direction in which the first flow path extends, and that communicates with the first flow path and the material supply port. The nozzle section includes a nozzle and a shut-off pin that controls opening and closing of the nozzle by advancing and retreating.

The present application is based on, and claims priority from JP Application Serial Number 2024-228273, filed Dec. 25, 2024, the disclosure of which is hereby incorporated by reference herein in its entirety.

### BACKGROUND

### 1. Technical Field

The present disclosure relates to an injection molding device and an injection unit.

### 2. Related Art

JP-A-2010-274589 discloses an injection device for injection molding a resin that has low viscosity and is injection molded at low injection pressure, such as liquid curable resin material typified by a liquid silicone resin. In this injection device, a shut-off pin for opening and closing a nozzle opening is arranged inside a nozzle through which a resin is injected.

To solve the problem that there is a possibility of causing various problems such as a decrease in injection pressure depending on a connection configuration between a nozzle section including the shut-off pin and a supply path for supplying a resin into the nozzle section, and there is room for improvement.

### SUMMARY

According to a first aspect of the present disclosure, an injection molding device that performs injection molding of a molded article using a molding die is provided.

The injection molding device includes an injection unit that injects material into the molding die and a molding die opening and closing unit to which the molding die is attached and that opens and closes the molding die. The injection unit includes a material supply port through which the material is supplied, a material flow path that communicates with the material supply port and through which the material flows, an injection control section that includes a cylinder that communicates with the material flow path and a plunger that advances and retreats in the cylinder, and that controls injection of the material, and a nozzle section that communicates with the cylinder and that injects the material. The material flow path includes a first flow path that communicates with the cylinder and a second flow path extending in a second direction intersecting a first direction in which the first flow path extends, and that communicates with the first flow path and the material supply port. The nozzle section includes a nozzle and a shut-off pin that controls opening and closing of the nozzle by advancing and retreating. The nozzle section communicates with the cylinder such that a third direction in which the plunger extends and a fourth direction in which the shut-off pin extends intersect each other, and the cylinder and the nozzle section communicate with each other without any other member therebetween.

According to a second aspect of the present disclosure, an injection unit is provided.

The injection unit includes a material supply port through which a material is supplied; a material flow path that communicates with the material supply port and through which the material flows; an injection control section that includes a cylinder that communicates with the material flow path and a plunger that advances and retreats in the cylinder, and that controls injection of the material; and a nozzle section that communicates with the cylinder and that injects the material, wherein the material flow path includes a first flow path that communicates with the cylinder and a second flow path extending in a second direction intersecting a first direction in which the first flow path extends, and that communicates with the first flow path and the material supply port, the nozzle section includes a nozzle and a shut-off pin that controls opening and closing of the nozzle by advancing and retreating, the nozzle section communicates with the cylinder such that a third direction in which the plunger extends and a fourth direction in which the shut-off pin extends intersect each other, and the cylinder and the nozzle section communicate with each other without any other member therebetween.

### BRIEF DESCRIPTION OF THE DRAWINGS

FIG. 1 is a cross-sectional view illustrating a schematic configuration of an injection molding device.

FIG. 2 is a cross-sectional view illustrating a schematic configuration of the injection molding device.

FIG. 3 is a perspective view illustrating a connection state between a movement section and an injection section.

FIG. 4 is a perspective view illustrating a state in which the injection section is connected to the movement section.

FIG. 5 is a view of a state in which the injection section is fixed to the movement section when viewed from below.

FIG. 6 is a cross-sectional view illustrating a state in which the injection section is fixed to the movement section.

FIG. 7 is a view illustrating a detailed configuration of a material flow path.

FIG. 8 is an enlarged view of a part of the material flow path.

FIG. 9 is a diagram illustrating a positional relationship between a plug and the material flow path.

### DESCRIPTION OF EMBODIMENTS

### A. First Embodiment

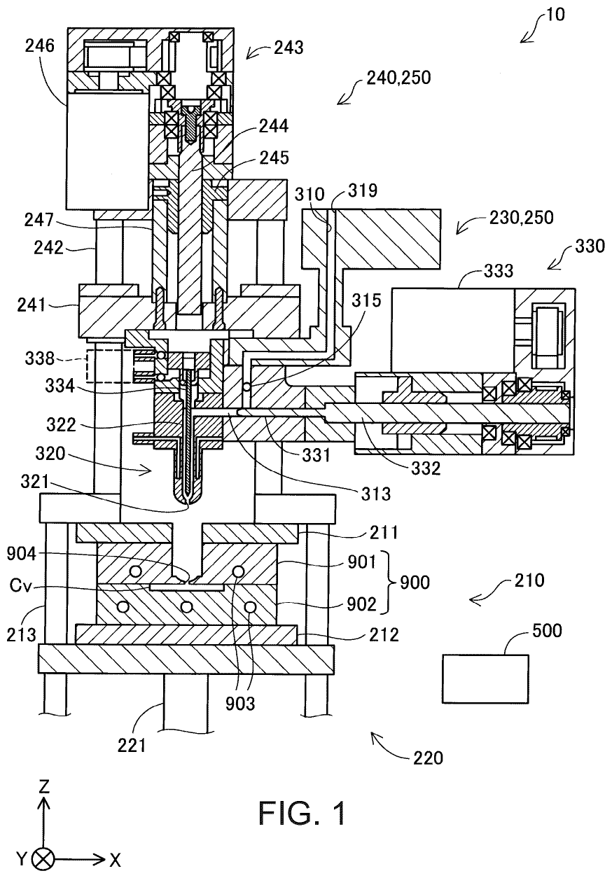

FIG. 1 is a cross-sectional view illustrating a schematic configuration of an injection molding device 10. In FIG. 1, arrows indicating X, Y, and Z directions orthogonal to each other are illustrated. The X direction and the Y direction are directions parallel to a horizontal plane. The Z direction is a direction parallel to a vertical direction. The X, Y, and Z directions in FIG. 1 and the X, Y, and Z directions in other drawings indicate the same directions. When a direction is specified, positive and negative signs are used together with a direction notation, wherein a positive direction, which is a direction indicated by the arrow, is “+” and a negative direction, which is a direction opposite to the direction indicated by the arrow, is “−”. A+Z direction is also referred to as an upper direction, and a −Z direction is also referred to as a lower direction.

The injection molding device 10 molds a molded article by injecting material into a molding die 900 mounted on the injection molding device 10. In the present embodiment, liquid material having relatively low viscosity is used as material of the molded article. In the present embodiment, two component thermosetting material in which a first liquid and a second liquid are mixed in advance is used as the liquid material. The first liquid contains a main agent of the thermosetting material. As the main agent, for example, silicone polymer is used. The second liquid contains a polymerization initiator that initiates a polymerization reaction of the two component thermosetting material.

The injection molding device 10 includes a molding die opening and closing unit 220, an injection unit 250, and a control section 500. In the present embodiment, the injection unit 250 and the molding die opening and closing unit 220 are arranged in a gravity direction, that is, the −Z direction. That is, the injection molding device 10 in the present embodiment is configured as a vertical injection molding device 10.

The control section 500 is configured by a computer including one or a plurality of processors, a memory, and an input/output interface that inputs and outputs signals to and from the outside. The control section 500 exhibits various functions such as a function of executing a process of molding a molded article by the processor executing a program or a command read on the main storage device. Note that the control section 500 may be realized by a configuration in which a plurality of circuits for realizing at least a part of each function are combined instead of being configured by the computer.

The molding die opening and closing unit 220 includes a fixing section 210. The molding die 900 is attached to the fixing section 210. The fixing section 210 includes a fixed plate 211 and a movable plate 212. The fixed plate 211 and the movable plate 212 are plate-shaped members. The fixed plate 211 is fixed to an upper end side of tie bars 213 extending in the vertical direction so that the plate surface thereof is parallel to a horizontal direction. The movable plate 212 is arranged below the fixed plate 211 so as to face the fixed plate 211 such that the plate surface thereof is parallel to the horizontal direction. A fixed molding die 901 of the molding die 900 is mounted on the fixed plate 211, and a movable molding die 902 of the molding die 900 is mounted on the movable plate 212. The fixed molding die 901 and the movable molding die 902 are respectively mounted on the fixed plate 211 and the movable plate 212 by bolts or clamping mechanisms.

The molding die opening and closing unit 220 opens and closes the molding die 900 mounted on the fixing section 210. The molding die opening and closing unit 220 rotates a ball screw 221 by driving a motor (not illustrated) under the control of the control section 500, and moves the movable plate 212 coupled to the ball screw 221 along the tie bars 213. The movable plate 212 moves along the tie bars 213, thereby opening and closing the molding die 900 mounted on the fixing section 210. The movable plate 212 moves in the +Z direction to clamp the molding die 900, and the movable plate 212 moves in the −Z direction to open the molding die 900. When the molding die 900 is clamped, a cavity Cv is defined by the fixed molding die 901 and the movable molding die 902. The cavity Cv is a space having a shape corresponding to the shape of a molded article.

In the present embodiment, the molding die 900 includes heaters 903 for heating the molding die 900 to cure material filled in the cavity Cv. The temperature of the heater 903 is controlled by the control section 500. The molding die 900 may be made of metal, resin, or ceramic. The metal molding die 900 is also referred to as a metal mold.

The fixed molding die 901 includes a gate opening 904, which is a hole penetrating the fixed molding die 901 in the vertical direction. Material is filled in the cavity Cv through the gate opening 904. The fixed molding die 901 is mounted on the fixing section 210 such that the gate opening 904 faces a nozzle opening 321 of a nozzle section 320 in the vertical direction.

The injection unit 250 includes an injection section 230 and a movement section 240.

The injection section 230 injects material supplied from an external tank through a pump. The injection section 230 is provided above the fixing section 210 and the molding die opening and closing unit 220. The injection section 230 is provided so as to be movable in the vertical direction along guide members 242 (to be described later). The injection section 230 includes a material supply port 319, a material flow path 310, the nozzle section 320, and an injection control section 330.

Material is supplied to the material supply port 319 from the outside.

The material flow path 310 communicates with the material supply port 319. Material flows inside the material flow path 310. A valve section 315 configured as a check valve is arranged in the material flow path 310.

The injection control section 330 controls injection of material under the control of the control section 500. The injection control section 330 includes a cylinder 313, a plunger 332, and a plunger drive section 333 including a motor. The cylinder 313 communicates with the material flow path 310. The plunger 332 advances and retreats in the cylinder 313 along the X direction by the control section 500 controlling the driving of the plunger drive section 333. The plunger 332 retreats in an injection cylinder 331 in a direction away from the nozzle section 320, and thus material is sucked into the injection cylinder 331 and is measured. The plunger 332 advances in the injection cylinder 331 in a direction approaching the nozzle section 320, and thus the sucked material is supplied to the nozzle section 320.

The nozzle section 320 injects the material supplied by the injection control section 330. The nozzle section 320 includes a nozzle flow path 322 and a shut-off pin 334. The nozzle flow path 322 communicates with the cylinder 313. The nozzle opening 321 is formed at a tip end of the nozzle section 320. The shut-off pin 334 advances and retreats in the nozzle flow path 322 along the Z direction to control opening and closing of the nozzle opening 321.

The shut-off pin 334 is inserted into the nozzle flow path 322 from an end section of the nozzle flow path 322 on a side opposite to the nozzle opening 321. The shut-off pin 334 is a columnar member having a diameter smaller than a diameter of the nozzle flow path 322, and is provided so as to be movable in the nozzle flow path 322 along the Z direction. The shut-off pin 334 is driven by a shut-off pin drive section 338 under the control of the control section 500. In the present embodiment, the shut-off pin drive section 338 is connected to the nozzle section 320 in the X direction intersecting the Z direction in which the nozzle section 320 and a holding plate 260 (to be described later) are arranged. More specifically, the shut-off pin drive section 338 is connected to the nozzle section 320 on an opposite side of the injection control section 330.

The shut-off pin drive section 338 includes, for example, an air cylinder, and moves the shut-off pin 334 in the nozzle flow path 322 using compressed air. The nozzle opening 321 is closed by an end section of a nozzle opening 321 side of the shut-off pin 334 by the shut-off pin 334 moving in the −Z direction inside the nozzle flow path 322, and injection of material from the nozzle opening 321 is stopped. The nozzle opening 321 is opened by the shut-off pin 334 moving in the +Z direction inside the nozzle flow path 322, and material can be injected from the nozzle opening 321. The shut-off pin drive section 338 is not limited to the air cylinder, and may drive the shut-off pin 334 using a motor or a gear.

The movement section 240 is provided above the injection section 230. The movement section 240 moves the injection unit 250 with respect to the molding die opening and closing unit 220. The movement section 240 includes a movable member 241, guide members 242, a base section 243, a screw shaft 244, a ball nut 245, and a movement motor 246. The screw shaft 244 and the ball nut 245 constitute a ball screw.

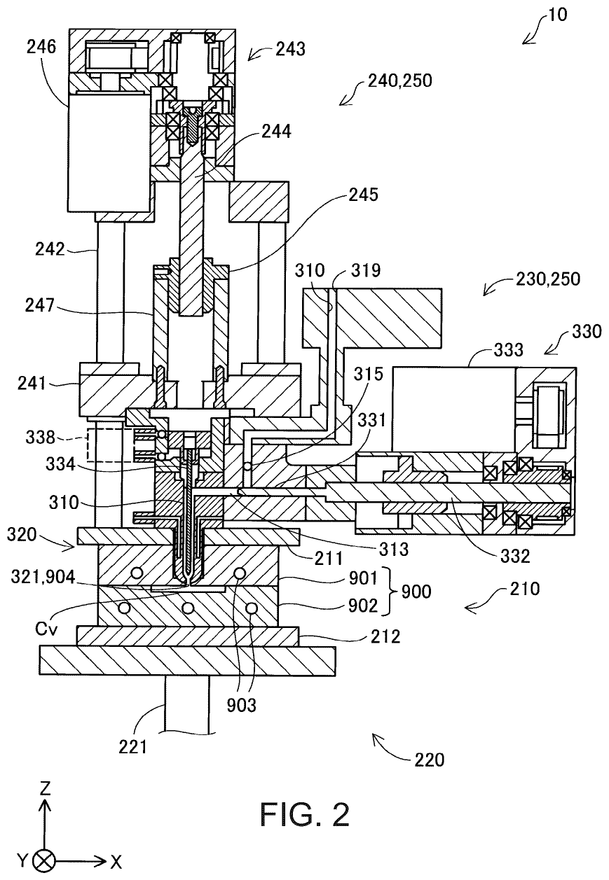

The injection section 230 is fixed to the movable member 241. The movable member 241 is attached to the guide members 242 so as to be movable along the guide members 242, which are columnar members extending vertically upward from an upper section of the fixing section 210. The base section 243 is fixed to upper ends of the guide members 242. The screw shaft 244 is fixed to the base section 243 so as to protrude downward from the base section 243. An axial direction of the screw shaft 244 is a direction along the vertical direction. The ball nut 245 is attached to the screw shaft 244 and is fixed to a connection member 247 fixed to the movable member 241. The movement motor 246 is driven under the control of the control section 500 and rotates the screw shaft 244 around the axis. When the screw shaft 244 rotates, the ball nut 245, the connection member 247, and the movable member 241 move in the vertical direction, and accordingly, the injection section 230 moves in the vertical direction. The injection section 230 moves in the −Z direction, and thus the nozzle section 320 comes into contact with the fixed molding die 901 so that the nozzle opening 321 and the gate opening 904 communicate with each other. The injection section 230 moves in the +Z direction, and thus the nozzle section 320 is separated from the fixed molding die 901. FIG. 2 illustrates a state in which the injection section 230 is moved to a position where the nozzle section 320 and the fixed molding die 901 are in contact with each other.

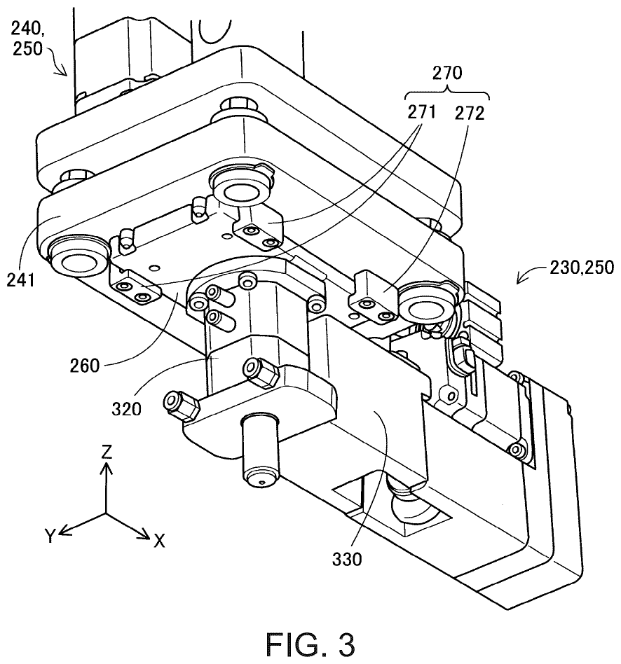

FIG. 3 is a perspective view illustrating a connection state between the movement section 240 and the injection section 230 included in the injection unit 250. In FIG. 3, the guide members 242 and the like are not illustrated. In the present embodiment, the injection unit 250 includes the holding plate 260. The holding plate 260 is connected to the injection section 230 of the injection unit 250 and holds the injection section 230. In the present embodiment, the nozzle section 320 of the injection section 230 is connected to the holding plate 260. Specifically, an end section of the nozzle section 320 of the injection section 230 in the +Z direction is connected to the holding plate 260 by a bolt. The injection control section 330 of the injection section 230 is connected to the nozzle section 320. That is, the injection control section 330 is connected to the holding plate 260 via the nozzle section 320. The holding plate 260 has a substantially rectangular flat plate shape. A longitudinal direction of the holding plate 260 is along the X direction. The holding plate 260 is arranged below the movable member 241 and parallel to the movable member 241.

The movement section 240 includes a support section 270 that supports the holding plate 260. The support section 270 is fixed to a surface of the movable member 241 of the movement section 240 on a −Z direction side. The support section 270 in the present embodiment is configured by a plurality of L-shaped fixtures. Specifically, the support section 270 includes a pair of first fixtures 271 and a pair of second fixtures 272. The pair of first fixtures 271 are arranged such that distal end sections bent in an L-shape face each other along the Y direction. The pair of second fixtures 272 are arranged such that distal end sections bent in an L-shape face each other along the Y direction. The arrangement interval in the Y direction between the fixtures included in the pair of first fixtures 271 is equal to the arrangement interval in the Y direction between the fixtures included in the pair of second fixtures 272. The pair of first fixtures 271 and the pair of second fixtures 272 are arranged in the X direction.

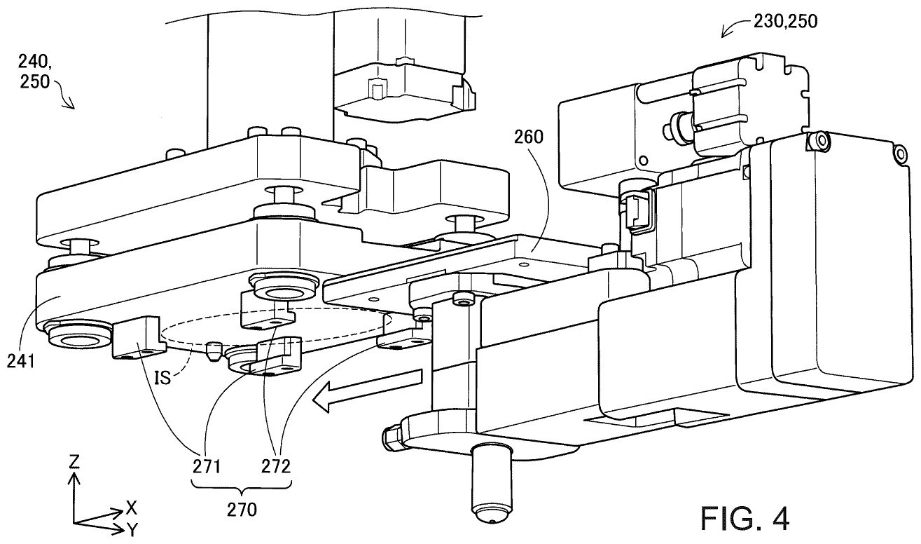

FIG. 4 is a perspective view illustrating a state in which the injection section 230 is connected to the movement section 240. As described above, the support section 270 is configured by the pair of first fixtures 271 and the pair of second fixtures 272, and thus, an insertion space IS for inserting the holding plate 260 along a −X direction is formed below the movable member 241. When an operator fixes the injection section 230 to the movement section 240, the operator inserts the holding plate 260 to which the injection section 230 is connected into the insertion space IS from a +X direction toward the −X direction. When the operator removes the injection section 230 from the movement section 240 at the time of maintenance or washing of the injection section 230, the operator moves the holding plate 260 to which the injection section 230 is connected from the −X direction toward the +X direction. As described above, in the present embodiment, the holding plate 260 that holds the injection section 230 is provided so as to be slidable with respect to the support section 270 included in the movement section 240.

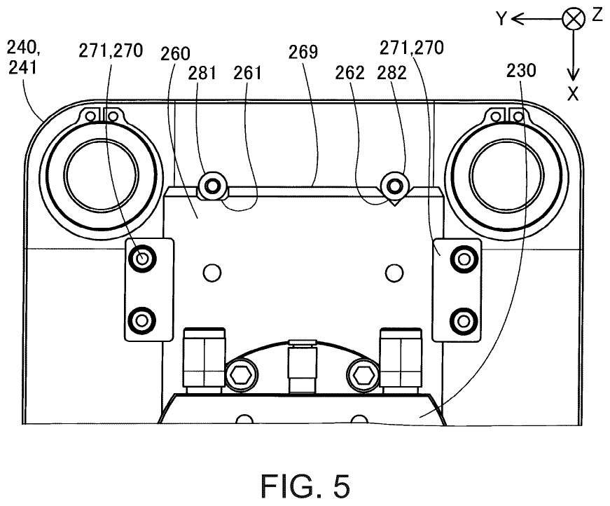

FIG. 5 is a view of a state in which the injection section 230 is fixed to the movement section 240 when viewed from below. The holding plate 260 includes a first groove section 261 and a second groove section 262 having different shapes on an end surface 269 in a direction in which the holding plate 260 slides with respect to the support section 270. In the present embodiment, when the holding plate 260 is viewed from below, the first groove section 261 has a U-shape, and the second groove section 262 has a V-shape.

The movement section 240 includes a first restriction section 281 and a second restriction section 282. In the present embodiment, the first restriction section 281 and the second restriction section 282 are provided on a lower surface of the movable member 241. The first restriction section 281 and the second restriction section 282 have a columnar shape with the same diameter. The first restriction section 281 and the second restriction section 282 are arranged at an interval in the Y direction, and are at the same position in the X direction.

The first restriction section 281 contacts the first groove section 261 formed in the holding plate 260 when the holding plate 260 is supported by the support section 270. The second restriction section 282 contacts the second groove section 262 formed in the holding plate 260 when the holding plate 260 is supported by the support section 270. The length of the first groove section 261 in a direction along the end surface 269 is larger than the diameter of the first restriction section 281. When the second restriction section 282 contacts the second groove section 262 having a triangular shape at two points, the first restriction section 281 contacts the first groove section 261 having a rectangular shape at one point. The first restriction section 281 and the second restriction section 282 function as restriction sections that restrict the movement of the holding plate 260 in the −X direction with respect to the support section 270. The first restriction section 281 and the second restriction section 282 function as positioning sections that position the holding plate 260 with respect to the support section 270 in the X direction and the Y direction.

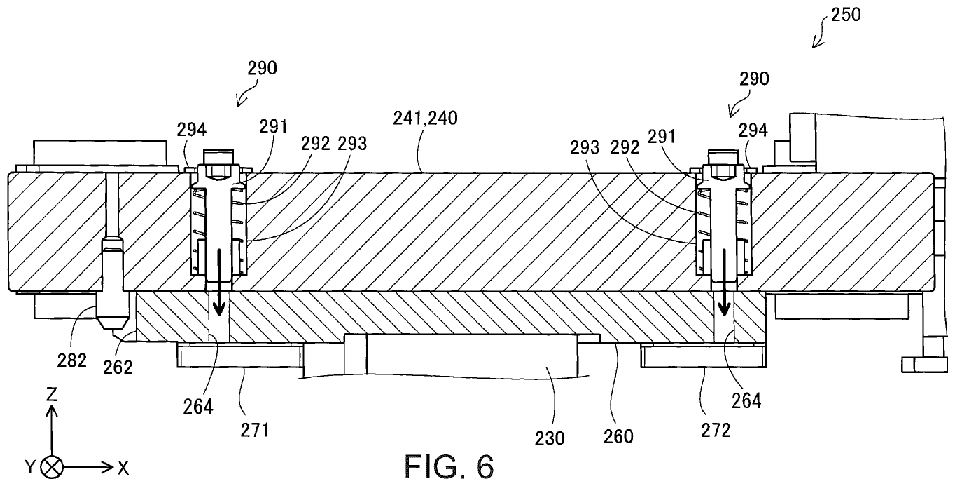

FIG. 6 is a cross-sectional view illustrating a state in which the injection section 230 is fixed to the movement section 240. The injection unit 250 includes fixing mechanisms 290 that fix the holding plate 260 to the movement section 240. In the present embodiment, four fixing mechanisms 290 are arranged at positions corresponding to four corners of the holding plate 260, respectively. The fixing mechanism 290 includes a screw 291 and a spring 292 provided around a thread of the screw 291. The spring 292 constantly biases the screw 291 in a direction opposite to the holding plate 260, that is, in the +Z direction. After the holding plate 260 is supported by the support section 270, the screw 291 is screwed into a screw hole 264 of the holding plate 260 through a through hole 293 provided in the movable member 241, and thus the injection section 230 held by the holding plate 260 is fixed to the movement section 240. In the present embodiment, a retaining member 294 is arranged in an opening section of the through hole 293 so that the screw 291 does not come off from the through hole 293.

When the holding plate 260 is moved in the −X direction and supported by the support section 270, the screw 291 is biased in a direction opposite to the holding plate 260 by the spring 292, and thus the screw 291 is not exposed from the through hole 293 toward the holding plate 260. This makes it possible to easily move the holding plate 260 toward the insertion space IS. When the injection section 230 is removed from the movement section 240, the screw 291 is loosened and the screw 291 is removed from the screw hole 264. Then, the holding plate 260 is supported by the support section 270 without falling in the −Z direction. In this state, the screw 291 is also biased by the spring 292 in a direction opposite to the holding plate 260, and thus the screw 291 is not exposed from the through hole 293 toward the holding plate 260. Therefore, an operator can easily remove the injection section 230 from the movement section 240.

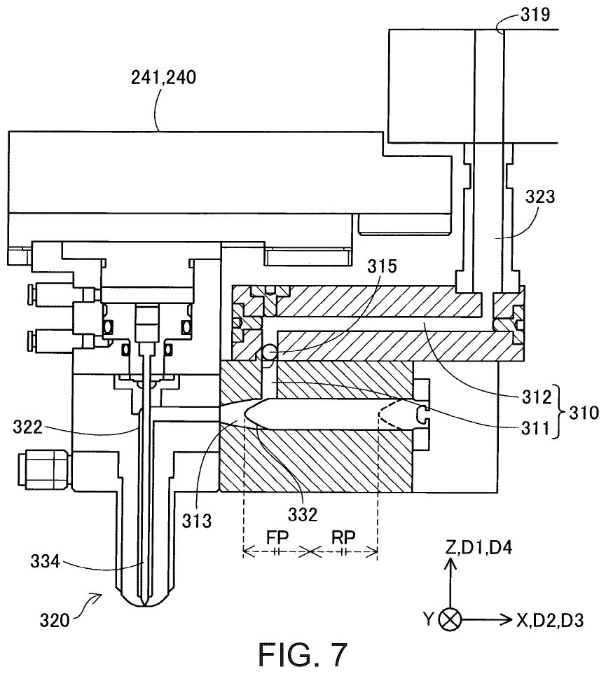

FIG. 7 is a view illustrating a detailed configuration of the material flow path 310. The material flow path 310 includes a first flow path 311 and a second flow path 312. The first flow path 311 communicates with the cylinder 313. The first flow path 311 extends along a first direction D1. The first direction D1 is the Z direction in the present embodiment. The first flow path 311 communicates with the cylinder 313 at an end section of the first flow path 311 in the −Z direction. In the present embodiment, the first flow path 311 is connected to the cylinder 313 in the vicinity of a tip end section of the plunger 332 in a state where the plunger 332 is most advanced in the cylinder 313. When a distance from a position of a tip end of the plunger 332 when the plunger 332 is most advanced to a position of the tip end of the plunger 332 when the plunger 332 is most retreated is divided into two equal portions, that is, a front portion FP and a rear portion RP, the first flow path 311 is connected to the cylinder 313 at a position corresponding to the front portion FP.

In the present embodiment, the valve section 315 is provided in the first flow path 311. The valve section 315 blocks flow in the material flow path 310 in at least a partial period during injection of material. More specifically, the valve section 315 blocks flow in the material flow path 310 so as to prevent backflow of material from the cylinder 313 toward the material supply port 319 in at least a partial period during injection of material. The valve section 315 does not need to block flow in the material flow path 310 in the entire period during injection of material. For example, a small amount of material is allowed to pass through the valve section 315 at the start of an advancing operation of the plunger 332 at the time of injection of the material or at the end of the advancing operation.

The second flow path 312 communicates with the first flow path 311 and the material supply port 319. The second flow path 312 extends in a second direction D2 intersecting the first direction D1. The second direction D2 is the X direction in the present embodiment. The second flow path 312 communicates with the first flow path 311 at an end section of the second flow path 312 in the −X direction. The second flow path 312 communicates with the material supply port 319 at an end section of the second flow path 312 in the +X direction. More specifically, at the end section of the second flow path 312 in the +X direction, the second flow path 312 communicates with the material supply port 319 through a third flow path 323 extending in the first direction D1. The third flow path 323 is a part of the material flow path 310.

The nozzle section 320 communicates with the cylinder 313 such that a third direction D3 in which the plunger 332 extends and a fourth direction D4 in which the shut-off pin 334 extends intersect each other. The third direction D3 is the X direction in the present embodiment. The fourth direction D4 is the Z direction in the present embodiment. That is, in the present embodiment, both the first direction D1 and the fourth direction D4 are the Z direction, and both the second direction D2 and the third direction D3 are the X direction. The cylinder 313 and the nozzle section 320 communicate with each other without any other member therebetween. That is, the cylinder 313 and the nozzle section 320 are connected to each other at the shortest distance.

When the movement section 240 including the movable member 241, the tie bars 213, and the like is viewed along the fourth direction D4 in which the shut-off pin 334 extends, the movement section 240 is positioned to overlap the nozzle section 320. That is, in the present embodiment, the movement section 240 and the nozzle section 320 are arranged in the gravity direction.

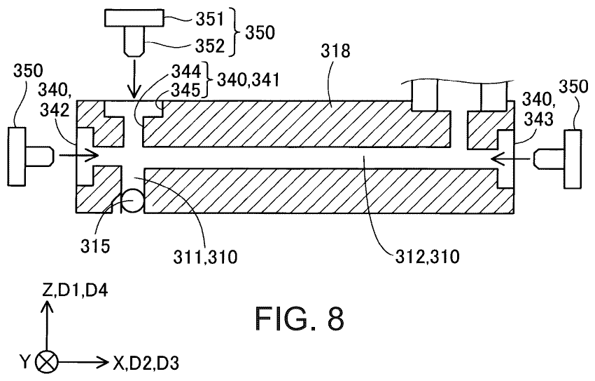

FIG. 8 is an enlarged view of a part of the material flow path 310. The material flow path 310 includes an opening 340. The opening 340 is provided on at least one of wall surfaces of a material flow path forming member 318 that forms the material flow path 310, at a position that overlaps the first flow path 311 in the first direction D1, or at a position that overlaps the second flow path 312 in the second direction D2. In the present embodiment, as the opening 340, a first opening 341, a second opening 342, and a third opening 343 are provided in the material flow path 310. The first opening 341 is provided at a position overlapping the first flow path 311 in the first direction D1, and the second opening 342 and the third opening 343 are provided at positions overlapping the second flow path 312 in the second direction D2.

Each opening 340 is provided with a plug 350 that is attachable to and detachable from the opening 340. The plug 350 in the present embodiment has a screw-like shape including a head section 351 and a male screw section 352. The opening 340 includes a recess section 344 that accommodates the head section 351 and a female screw section 345 into which the male screw section 352 of the plug 350 is screwed. The opening 340 is closed by screwing the male screw section 352 of the plug 350 into the female screw section 345 of the opening 340. An operator can clean the inside of the material flow path 310 by removing the injection section 230 from the movement section 240 and removing the plug 350 from the opening 340.

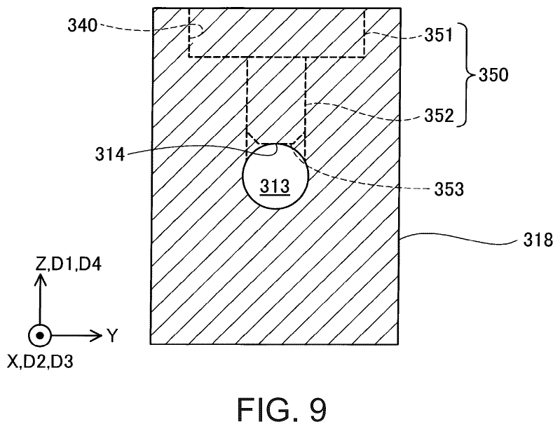

FIG. 9 is a diagram illustrating a positional relationship between the plug 350 and the material flow path 310. FIG. 9 illustrates the arrangement of the plug 350 when the plug 350 is viewed along an extension direction of the second flow path 312. When the plug 350 is attached to the opening 340, an end 353 of the plug 350 on a material flow path 310 side forms a part of an inner wall surface 314 of the material flow path 310. At this time, at least a part of the end 353 of the plug 350 on a material flow path 310 side is positioned on the same plane as the inner wall surface 314 of the material flow path 310. In the present embodiment, the end 353 of the plug 350 includes a circular end surface, and the center thereof is present on the same cylindrical surface as the inner wall surface 314 of the material flow path 310. The end 353 of the plug 350 is not limited to a flat shape, and may have a point-like shape when an end section of the plug 350 is formed at an acute angle or formed by a curved surface.

According to the injection molding device 10 of the first embodiment described above, the cylinder 313 provided in the injection control section 330 and the nozzle section 320 are directly connected to each other. Therefore, injection pressure generated by the injection control section 330 can be efficiently transmitted to the nozzle section 320. As a result, a decrease in injection pressure is suppressed, and material can be suitably injected.

In the present embodiment, the material flow path 310 includes the first flow path 311 along the first direction D1 and the second flow path 312 along the second direction D2 intersecting the first direction D1, and the second flow path 312 communicates with the material supply port 319 via the third flow path 323 along the first direction D1. By configuring the material flow path 310 to be bent in this manner, the material flow path 310 can be arranged so as to thread between the movement section 240 and the injection control section 330. As a result, the movement section 240 and the injection control section 330 can be suitably arranged in the injection molding device 10. Therefore, for example, in a case where the material flow path 310 extends only in one direction, there is a possibility that it is necessary to lengthen the injection control section 330 along the second direction D2 or to arrange the nozzle section 320 to be shifted from the movement section 240, but in the present embodiment, there is no need to do so. As a result, the weight balance of the entire injection molding device 10 is prevented from becoming unbalanced, and the rigidity and strength of the entire device can be prevented from being lowered.

In the present embodiment, the first flow path 311 in the material flow path 310 is connected to the cylinder 313 in the vicinity of a tip end section of the plunger 332 in a state where the plunger 332 is most advanced in the cylinder 313. Therefore, material can be suitably sucked from the material flow path 310 and measured by a retreating operation of the plunger 332.

In the present embodiment, the material flow path 310 includes the valve section 315 that blocks flow in the material flow path 310 in at least a partial period during injection of material. Therefore, injection pressure generated by an advancing operation of the plunger 332 provided in the injection control section 330 can be more efficiently transmitted to the nozzle section 320.

In the present embodiment, the valve section 315 is provided in the first flow path 311 connected to the cylinder 313. Therefore, the valve section 315 is provided at a position close to the injection control section 330, and thus, injection pressure generated by the injection control section 330 can be more efficiently transmitted to the nozzle section 320.

In the present embodiment, the material flow path 310 includes the opening 340 at least one of a position overlapping the first flow path 311 in the first direction D1 or a position overlapping the second flow path 312 in the second direction D2, and the opening 340 is provided with the plug 350 that is attachable to and detachable from the opening 340. Therefore, by removing the plug 350 provided in the material flow path 310, the inside of the material flow path 310 can be easily washed through the opening 340.

In the present embodiment, at least a part of the end 353 of the plug 350 on a material flow path 310 side and the inner wall surface 314 of the material flow path 310 are positioned on the same plane. Therefore, the presence of the plug 350 suppresses material from accumulating in the material flow path 310, and suppresses a decrease in the injection efficiency. Since the accumulation of material is suppressed, when washing the inside of the material flow path 310, a washing step can be suppressed from taking a long time.

In the present embodiment, the movement section 240 that moves the injection unit 250 with respect to the molding die opening and closing unit 220 is positioned to overlap the nozzle section 320 when viewed along a direction in which the shut-off pin 334 extends. Therefore, the injection control section 330 can be positioned near the nozzle section 320. As a result, when the injection unit 250 moves with respect to the molding die opening and closing unit 220, a load applied to the movement section 240 such as the tie bars 213 can be reduced as compared with a case where the injection control section 330 is positioned near the movement section 240. Therefore, the life of the movement section 240 can be extended.

In the present embodiment, the movement section 240 includes the support section 270 for supporting the holding plate 260 that holds the injection section 230, and the holding plate 260 is provided so as to be slidable with respect to the support section 270. Therefore, when the injection section 230 held by the holding plate 260 is removed from the movement section 240, the holding plate 260 is supported by the support section 270, and in this state, the holding plate 260 can be slid and moved from the support section 270. Therefore, when washing or maintenance of the injection section 230 is performed, the injection section 230 can be easily removed from the movement section 240.

In the present embodiment, the injection unit 250 and the molding die opening and closing unit 220 are arranged in the gravity direction. That is, the injection molding device 10 of the present embodiment is configured as a vertical injection molding device 10. According to the present embodiment, in such a vertical injection molding device 10, the injection section 230 can be easily removed from the movement section 240. In particular, in the present embodiment, the support section 270 supports the holding plate 260 from vertically below. Therefore, when the injection section 230 is removed from the movement section 240, the injection section 230 can be easily removed without falling. By this, when the injection section 230 is removed, it is not necessary to increase the number of persons for supporting the injection section 230. Therefore, the injection section 230 can be easily removed without increasing the number of man-hours such as increasing the number of operators. According to the present embodiment, the injection section 230 can be easily removed and also easily mounted. Therefore, it is easy to mount another injection section 230 on the injection molding device 10 during washing of the injection section 230, and thus, it is possible to minimize the downtime of the device and to improve the manufacturing efficiency of a molded article.

In the present embodiment, the nozzle section 320 includes the shut-off pin 334 that advances and retreats in the nozzle flow path 322. Therefore, the injection molding device 10 can inject material having relatively low viscosity. As a result, in the injection molding device 10 that injects material having low viscosity, the injection section 230 can be easily removed.

In the present embodiment, the nozzle section 320 is connected to the holding plate 260, and the injection control section 330 is connected to the nozzle section 320. With such a configuration, since it is not necessary to connect the injection control section 330 to the holding plate 260, the size of the holding plate 260 can be reduced. As a result, the injection molding device 10 can be downsized.

In the present embodiment, the shut-off pin drive section 338 that drives the shut-off pin 334 is connected to the nozzle section 320 in a direction intersecting a direction in which the nozzle section 320 and the holding plate 260 are arranged. Therefore, it is possible to reduce the possibility that the shut-off pin drive section 338 interferes with other components when the holding plate 260 is slid and moved. As a result, the injection section 230 can be easily removed.

In the present embodiment, the injection unit 250 includes the fixing mechanism 290 that fixes the holding plate 260 to the movement section 240. The fixing mechanism 290 includes the screw 291 and the spring 292 provided around the thread of the screw 291. The screw 291 is screwed into the screw hole 264 formed in the holding plate 260 through the through hole 293 provided in the movement section 240. According to such an aspect, when the screw 291 is removed from the screw hole 264, the screw 291 can be reliably separated from the holding plate 260 by the spring 292. Therefore, the injection section 230 can be easily removed. In the present embodiment, the retaining member 294 is arranged in the opening section of the through hole 293 into which the screw 291 is inserted. Therefore, it is possible to prevent the screw 291 from falling or being lost, and to reduce the number of steps of inserting the screw 291 into the through hole 293.

In the present embodiment, the holding plate 260 includes the first groove section 261 and the second groove section 262 having different shapes on the end surface 269 in a direction in which the holding plate 260 slides with respect to the support section 270, and the movement section 240 includes the first restriction section 281 that contacts the first groove section 261 and the second restriction section 282 that contacts the second groove section 262 when the holding plate 260 is supported by the support section 270. Therefore, the holding plate 260 can be positioned with respect to the movement section 240 with high accuracy. In particular, in the present embodiment, since the first groove section 261 has a U-shape and the second groove section 262 has a V-shape, even if there is an error in an interval between the first restriction section 281 and the second restriction section 282 for each individual, the holding plate 260 can be accurately positioned on the movement section 240.

### B. Other Embodiments

(B1) In the above-described embodiment, the first flow path 311 of the material flow path 310 is connected to the cylinder 313 in the vicinity of a tip end section of the plunger 332 in a state where the plunger 332 is most advanced in the cylinder 313. In contrast, the first flow path 311 may be connected to the cylinder 313 on a rear side of the tip end section of the plunger 332 in the state where the plunger 332 is most advanced in the cylinder 313.

(B2) In the above-described embodiment, the material flow path 310 includes the valve section 315 that blocks flow in the material flow path 310 in at least a partial period during injection of material. In contrast, the material flow path 310 may not include the valve section 315. For example, the valve section 315 may be provided outside the injection molding device 10. In the above-described embodiment, the valve section 315 is provided in the first flow path 311, but may be provided in the second flow path 312.

(B3) In the above-described embodiment, the opening 340 is provided in the material flow path 310, and the plug 350 is provided in the opening 340. In contrast, the material flow path 310 may not include the opening 340.

(B4) In the above-described embodiment, at least a part of the end 353 of the plug 350 provided in the opening 340 of the material flow path 310 on a material flow path 310 side is positioned on the same plane as the inner wall surface 314 of the material flow path 310. In contrast, at least a part of the end 353 of the plug 350 on the material flow path 310 side may be recessed from or protrude from the inner wall surface 314 of the material flow path 310.

(B5) In the above-described embodiment, when the movement section 240 including the movable member 241, the tie bars 213, and the like is viewed along the fourth direction D4 in which the shut-off pin 334 extends, the movement section 240 is positioned to overlap the nozzle section 320. In contrast, a configuration in which the movement section 240 and the nozzle section 320 do not overlap each other when viewed along the fourth direction D4 is also possible.

(B6) In the above-described embodiment, the injection unit 250 and the molding die opening and closing unit 220 are arranged in the gravity direction. In contrast, the injection unit 250 and the molding die opening and closing unit 220 may be arranged in the horizontal direction. That is, the injection molding device 10 may be configured as a horizontal injection molding device 10.

(B7) In the above-described embodiment, the injection molding device 10 includes the shut-off pin 334 and the shut-off pin drive section 338. In contrast, the injection molding device 10 may not include the shut-off pin 334 and the shut-off pin drive section 338. That is, the injection molding device 10 may be a molding machine that injects material having relatively high viscosity.

(B8) In the above-described embodiment, the nozzle section 320 is connected to the holding plate 260, and the injection control section 330 is connected to the nozzle section 320. In contrast, both the nozzle section 320 and the injection control section 330 may be connected to the holding plate 260.

(B9) In the above-described embodiment, the shut-off pin drive section 338 is connected to the nozzle section 320 in a direction intersecting a direction in which the nozzle section 320 and the holding plate 260 are arranged. In contrast, the shut-off pin drive section 338 may be connected to the nozzle section 320 along a direction in which the nozzle section 320 and the holding plate 260 are arranged.

(B10) In the above-described embodiment, the fixing mechanism 290 that fixes the holding plate 260 to the movement section 240 is provided in the injection molding device 10. The fixing mechanism 290 is not limited to a configuration including the screw 291 and the spring 292, and may be configured without the spring 292. The fixing mechanism 290 may be provided in the support section 270 provided in the movement section 240 instead of the movable member 241 provided in the movement section 240.

(B11) In the above-described embodiment, the holding plate 260 includes the first groove section 261 and the second groove section 262, and the movement section 240 includes the first restriction section 281 and the second restriction section 282. In contrast, the holding plate 260 may not include the first groove section 261 and the second groove section 262, and the movement section 240 may not include the first restriction section 281 and the second restriction section 282.

(B12) In the above-described embodiment, the support section 270 includes the pair of first fixtures 271 and the pair of second fixtures 272. The support section 270 is not limited thereto, and may include only the pair of first fixtures 271, and each fixture included in the pair of first fixtures 271 may have a shape elongated along the X direction. The shape of the first fixture 271 and the second fixture 272 is not limited to an L-shape, and may have a form in which a slit into which a side end of the holding plate 260 is inserted is provided on an inner surface, for example.

### C. Other Aspects

The present disclosure is not limited to the above-described embodiments, and can be realized in various configurations without departing from the spirit thereof. For example, the technical features of the embodiments corresponding to the technical features in each aspect described below can be appropriately replaced or combined in order to solve a part or all of the problems described above or to achieve a part or all of the effects described above. Unless the technical features are described as essential in the present specification, the technical features can be appropriately deleted.

(1) According to a first aspect of the present disclosure, an injection molding device that performs injection molding of a molded article using a molding die is provided.

The injection molding device includes an injection unit that injects material into the molding die and a molding die opening and closing unit to which the molding die is attached and that opens and closes the molding die, wherein the injection unit includes a material supply port through which the material is supplied, a material flow path that communicates with the material supply port and through which the material flows, an injection control section that includes a cylinder that communicates with the material flow path and a plunger that advances and retreats in the cylinder, and that controls injection of the material, and a nozzle section that communicates with the cylinder and that injects the material, the material flow path includes a first flow path that communicates with the cylinder and a second flow path extending in a second direction intersecting a first direction in which the first flow path extends, and that communicates with the first flow path and the material supply port, the nozzle section includes a nozzle and a shut-off pin that controls opening and closing of the nozzle by advancing and retreating, the nozzle section communicates with the cylinder such that a third direction in which the plunger extends and a fourth direction in which the shut-off pin extends intersect each other, and the cylinder and the nozzle section communicate with each other without any other member therebetween.

According to such an aspect, the cylinder provided in the injection control section and the nozzle section are directly connected to each other, and thus injection pressure generated in the injection control section can be efficiently transmitted to the nozzle section. As a result, a decrease in injection pressure is suppressed, and material can be suitably injected.

(2) The above-described aspect may be configured such that the first flow path is connected to the cylinder in vicinity of a tip end section of the plunger in a state where the plunger is most advanced in the cylinder.

In such an aspect, material can be suitably sucked from the material flow path and measured by a retreating operation of the plunger.

(3) The above-described aspect may be configured such that the material flow path includes a valve section that blocks flow in the material flow path in at least a partial period during injection of the material.

In such an aspect, injection pressure generated by the injection control section can be more efficiently transmitted to the nozzle section.

(4) The above-described aspect may be configured such that the valve section is provided in the first flow path.

According to such an aspect, since the valve section is provided at a position close to the injection control section, injection pressure generated by the injection control section can be more efficiently transmitted to the nozzle section.

(5) The above-described aspect may be configured such that the material flow path includes an opening, the opening is provided at least at one of a position overlapping the first flow path in the first direction and a position overlapping the second flow path in the second direction, and the opening is provided with a plug configured to be attached to and detached from the opening.

According to such an aspect, the inside of the material flow path can be easily washed from the opening by removing the plug.

(6) The above-described aspect may be configured such that at least a part of an end of the plug on a material flow path side is positioned on a same plane as an inner wall surface of the material flow path.

According to such an aspect, material is suppressed from accumulating in the material flow path, and the injection efficiency can be suppressed from decreasing. Since the accumulation of material is suppressed, a washing step can be suppressed from taking a long time.

(7) The above-described aspect may be configured such that the injection unit includes a movement section that moves the injection unit with respect to the molding die opening and closing unit and the movement section is positioned to overlap the nozzle section when the movement section is viewed along the fourth direction.

According to such an aspect, since the injection control section can be positioned near the nozzle section, when the injection unit moves with respect to the molding die opening and closing unit, a load applied to the movement section can be reduced as compared with a case where the injection control section is positioned near the movement section.

(8) According to a second aspect of the present disclosure, an injection unit is provided.

The injection unit includes a material supply port through which a material is supplied; a material flow path that communicates with the material supply port and through which the material flows; an injection control section that includes a cylinder that communicates with the material flow path and a plunger that advances and retreats in the cylinder, and that controls injection of the material; and a nozzle section that communicates with the cylinder and that injects the material, wherein the material flow path includes a first flow path that communicates with the cylinder and a second flow path extending in a second direction intersecting a first direction in which the first flow path extends, and that communicates with the first flow path and the material supply port, the nozzle section includes a nozzle and a shut-off pin that controls opening and closing of the nozzle by advancing and retreating, the nozzle section communicates with the cylinder such that a third direction in which the plunger extends and a fourth direction in which the shut-off pin extends intersect each other, and the cylinder and the nozzle section communicate with each other without any other member therebetween.

What is claimed is:

1. An injection molding device that performs injection molding of a molded article using a molding die, the injection molding device comprising:
an injection unit that is configured to inject material into the molding die and
a molding die opening and closing unit to which the molding die is attached and that is configured to open and close the molding die, wherein
the injection unit includes:
a material supply port through which the material is supplied;
a material flow path that communicates with the material supply port and through which the material flows;
an injection control section that includes a cylinder communicating with the material flow path and a plunger that is configured to advance and retreat in the cylinder, and that controls injection of the material; and
a nozzle section that communicates with the cylinder and that injects the material,
the material flow path includes:
a first flow path that communicates with the cylinder; and
a second flow path extending in a second direction intersecting a first direction in which the first flow path extends, and that communicates with the first flow path and the material supply port,
the nozzle section includes:
a nozzle; and
a shut-off pin that is configured to control opening and closing of the nozzle by advancing and retreating,
the nozzle section communicates with the cylinder such that a third direction in which the plunger extends and a fourth direction in which the shut-off pin extends intersect each other, and
the cylinder and the nozzle section communicate with each other without any other member therebetween.

2. The injection molding device according to claim 1, wherein
the first flow path is connected to the cylinder in vicinity of a tip end section of the plunger in a state where the plunger is most advanced in the cylinder.

3. The injection molding device according to claim 1, wherein
the material flow path includes a valve section that blocks flow in the material flow path in at least a partial period during injection of the material.

4. The injection molding device according to claim 3, wherein
the valve section is provided in the first flow path.

5. The injection molding device according to claim 1, wherein
the material flow path includes an opening,
the opening is: provided at least at one of a position overlapping the first flow path in the first direction and a position overlapping the second flow path in the second direction, and
the opening is provided with a plug configured to be attached to and detached from the opening.

6. The injection molding device according to claim 5, wherein
at least a part of an end of the plug on a material flow path side is positioned on a same plane as an inner wall surface of the material flow path.

7. The injection molding device according to claim 1, wherein
the injection unit includes a movement section that is configured to move the injection unit with respect to the molding die opening and closing unit, and
the movement section is positioned to overlap the nozzle section when the movement section is viewed along the fourth direction.

8. A injection unit, comprising:
a material supply port through which a material is supplied;
a material flow path that communicates with the material supply port and through which the material flows;
an injection control section that includes a cylinder that communicates with the material flow path and a plunger that is configured to advance and retreat in the cylinder, and that controls injection of the material; and
a nozzle section that communicates with the cylinder and that injects the material, wherein
the material flow path includes:
a first flow path that communicates with the cylinder; and
a second flow path extending in a second direction intersecting a first direction in which the first flow path extends, and that communicates with the first flow path and the material supply port,
the nozzle section includes:
a nozzle; and
a shut-off pin that is configured to control opening and closing of the nozzle by advancing and retreating,
the nozzle section communicates with the cylinder such that a third direction in which the plunger extends and a fourth direction in which the shut-off pin extends intersect each other, and
the cylinder and the nozzle section communicate with each other without any other member therebetween.
